(19) United States
(12) Patent Application Publication
(10) Pub. No.: US 2024/0247937 A1
(43) Pub. Date: Jul. 25, 2024

(54) METHOD AND SYSTEM FOR CREATING A VIRTUAL LANE FOR A VEHICLE

(71) Applicant: Continental Autonomous Mobility Germany GmbH, Ingolstadt (DE)

(72) Inventors: Bhanu Prakash Padiri, Bangalore (IN); Vijay Pathy, Bangalore (IN)

(73) Assignee: Continental Autonomous Mobility Germany GmbH, Ingolstadt (DE)

(21) Appl. No.: 18/681,040

(22) PCT Filed: Jul. 29, 2022
(86) PCT No.: PCT/EP2022/071319

§ 371 Date: Feb. 3, 2024

(30) Foreign Application Priority Data
Aug. 5, 2021 (GB) 2111291.7

(51) Int. Cl. G01C 21/28; B60W 30/10; B60W 50/14; G06T 3/00

(52) U.S. Cl. CPC G01C 21/28; B60W 30/10; B60W 50/14; G06T 3/00; B60W 2420/403

(57) ABSTRACT

A method and system for creating a virtual lane for a vehicle comprises receiving real-time values of vehicle dynamics parameters and location of one or more objects and transforming the received information into a world coordinate system. Further, the method comprises generating a bird's-eye view of the vehicle and creating and rendering a virtual lane corresponding to the vehicle on the bird's-eye view. Thereafter, the method comprises detecting if at least one of the one or more objects is in the virtual lane of the vehicle, and generating an alert when the at least one of the one or more objects are in the virtual lane. Thus, the present disclosure helps the vehicle avoid collisions with other objects/vehicles by dynamically altering the path when the other objects/vehicles are detected in the virtual lane of the vehicle.

### TECHNICAL FIELD

The present disclosure is generally related to autonomous vehicles and specifically related to method and system for creating a virtual lane for a vehicle.

### BACKGROUND

In general, a lane is a part of a roadway that is designated to be used by a single line of vehicles, to control and guide drivers through dedicated paths and reduce traffic conflicts on the roadway. Lanes have an extremely critical role in self-driving and/or autonomous vehicles. Information about accurate position of the lanes is used by the autonomous vehicles for maneuvering and to avoid the risk of running into the lanes of other vehicles or getting off the road.

Some of the existing techniques for automated lane detection suggest detecting the lanes by analyzing images captured by front-view cameras of a vehicle. Also, some of the existing methods suggest detecting the lanes using images from rear-view cameras of the vehicle. However, these methods use similar set of algorithms and techniques for analyzing the images obtained from both the front-view cameras and rear-view cameras of the vehicle. This causes various issues in lane detection. Firstly, accuracy of the lane detection suffers when the rear-view camera images are used at night or during bad weather conditions. Because, in a low-light condition, the lanes cannot be detected using the rear-view cameras as there will not be any headlights on the rear side of the vehicle. Therefore, unless there is a good lighting around the roadways or there are other vehicles approaching the vehicle from the behind, whose headlights are lighting the roadways, the rear-view cameras do not result in accurate lane detection.

In addition, unlike front-view cameras, the rear-view cameras are generally less expensive and hence may not provide mechanisms for handling blockages in the vision of the rear-view cameras. Such mechanisms are required in conditions like direct sunlight or rain for accurately predicting the lanes.

The problem increases when there is an emergency vehicle approaching the vehicle from behind, and the vehicle needs to shift lane for giving way to the emergency vehicle. The vehicle may not be able to shift lanes or give the way unless it can make accurate prediction about the current lane in which it is moving and the lane in which the emergency vehicle is approaching.

The information disclosed in this background of the disclosure section is only for enhancement of understanding of the general background and should not be taken as an acknowledgement or any form of suggestion that this information forms the prior art already known to a person skilled in the art.

### SUMMARY

Aspects of the present disclosure provide methods and system for creating a virtual lane for a vehicle and then detecting if one or more other vehicles or objects are within the virtual lane of the vehicle.

One aspect of this disclosure provides a method for creating a virtual lane for a vehicle, the method comprising transforming real-time values of vehicle dynamics parameters associated with the vehicle and location of the one or more objects into a world coordinate system. Further, the method comprises generating a bird's-eye view of the vehicle and a predetermined region surrounding the vehicle based on the world coordinate system. Subsequent to generating the bird's-eye view of the vehicle, the method comprises creating a virtual lane corresponding to the vehicle on the bird's-eye view of the vehicle.

Another aspect of the disclosure provides a lane creation system for creating a virtual lane for a vehicle. The lane creation system comprises a processor and at least one memory coupled to the processor. The memory stores instructions executable by the processor, which causes the processor to perform actions including transforming real-time values of the vehicle dynamics parameters associated with the vehicle and location of the one or more objects into a world coordinate system. Once the world coordinate system has been obtained, the processor generates a bird's-eye view of the vehicle and a predetermined region surrounding the vehicle based on the world coordinate system. Thereafter, the processor creates a virtual lane corresponding to the vehicle on the bird's-eye view of the vehicle.

The method and system of the present disclosure address various issues related to detection of lanes using rear-view cameras associated with the vehicle. Specifically, the present disclosure overcomes limitations of the rear-view cameras, arising due to low-light, no-light, or bad weather conditions. Also, the present disclosure reduces computational burden in comparison with the existing lane detection methods using rear-view cameras.

In an implementation, the present disclosure solves the limitations in the existing lane detection mechanisms by generating a bird's-eye view of the vehicle and plotting a virtual lane of the vehicle on the bird's-eye view using vehicle dynamics parameters including odometry information. Additionally, the present disclosure suggests using the bird's-eye view and the virtual lane of the vehicle to determine if any other object or vehicle (for example, an emergency vehicle) is in the virtual lane of the vehicle. Based on the determination, an alert may be generated for altering the path of the vehicle, for example to avoid collision with the other objects or vehicles and/or to give way for an emergency vehicle approaching vehicle from the rear.

The foregoing summary is illustrative only and is not intended to be in any way limiting. The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 is an exemplary schematic diagram illustrating movement of a vehicle according to one implementation of the present disclosure.

FIGS. 2A and 2B illustrate method of generating a bird's-eye view of the vehicle according to one implementation of the present disclosure.

FIGS. 3A and 3B illustrate a method of detecting lane of one or more other vehicles (for example, an emergency vehicle) according to one implementation of the present disclosure.

FIG. 4 shows a detailed block diagram of a lane creation system according to one implementation of the present disclosure.

FIG. 5 is a flow diagram illustrating an exemplary method of creating a virtual lane for a vehicle according to one implementation of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the following disclosure, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the spirit and the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

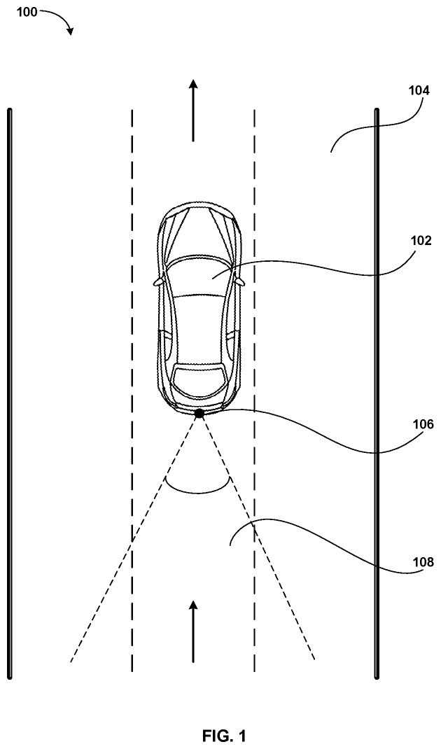

FIG. 1 is a schematic diagram 100 illustrating an exemplary setup according to one implementation of the present disclosure.

In an embodiment, the vehicle 102 may be a regular and/or human-driven vehicle, a self-driving vehicle, an autonomous vehicle, or a vehicle integrated with Advanced Driver-Assistance Systems (ADAS). In an embodiment, suppose, the vehicle 102 is moving on a multi-lane road 104. In an embodiment, the vehicle 102 may be integrated with and/or associated with a lane creation system proposed in the present disclosure for creating a virtual lane of the vehicle 102. In an embodiment, the vehicle 102 may be configured with at least one rear-view camera 106 for capturing scenes on the rear side of the vehicle 102, along the road 104. In an embodiment, the rear-view camera 106 may have a predefined field of view 108 (indicated by dotted lines in FIG. 1).

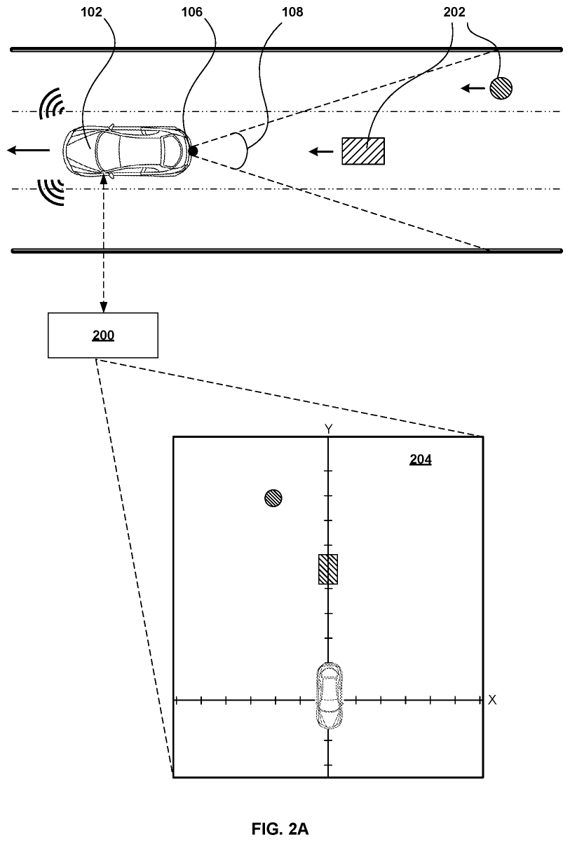

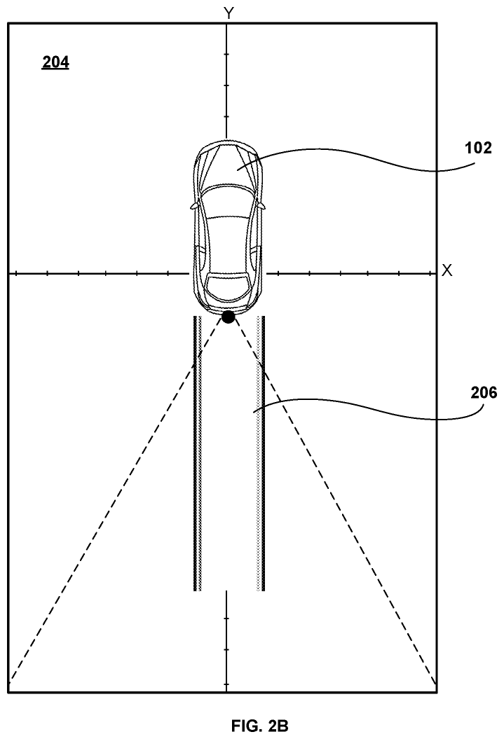

In existing scenario (that is, without the use of proposed lane creation system), due to various limitations in the rear-view cameras, the vehicle 102 may find it difficult to predict the lane on which one or more other vehicles are approaching the vehicle 102. As a result, the vehicle 102 may end up moving on the same lane as that of one or more other vehicles due to lack of accurate lane information. Consequently, the vehicle 102 may obstruct the movement of the one or more other vehicles. This could become a serious concern when at least one of the one or more other vehicles is an emergency vehicle or an ambulance. The proposed lane creation system addresses the above issues by accurately creating a virtual lane for the vehicle 102 and then detecting whether the one or more other vehicles are moving on the same lane, using a bird's-eye view of the vehicle 102 and a predetermined region surrounding the vehicle 102, as shown in FIGS. 2A and 2B.

In an embodiment, the lane creation system proposed in the present disclosure may be useful even when the vehicle 102 is not an autonomous vehicle (i.e., human-driven vehicle). Particularly, the proposed lane creation system may be used to assist drivers during the night, since the driver may not be able to distinguish if a vehicle approaching from behind is in the same lane as that of the vehicle 102 driven by the driver.

FIGS. 2A and 2B illustrate a method of generating a bird's-eye view 204 of the vehicle 102 according to some embodiments of the present disclosure.

In an embodiment, as shown in FIG. 2A, suppose there are two other vehicles 202 moving on the same road 104 as that of the vehicle 102 and approaching the vehicle 102 from behind. Suppose the rear-view camera 106 integrated with the vehicle 102 is capturing real-time images of the scene behind the vehicle 102, within the field of view 108. In an embodiment, the real-time images captured by the rear-view camera 106, along with real-time values of Vehicle Dynamics (VDY) parameters, may be shared with the lane creation system 200 using a wireless communication network connecting the vehicle 102 with the lane creation system 200.

In an embodiment, the vehicle dynamics parameters may include, without limiting to, odometry information associated with the vehicle 102. As an example, the odometry information may comprise, without limiting to, position information of the vehicle 102 and specifically, the relative position of the vehicle 102 from a point where the vehicle 102 started its movement. In addition, the vehicle dynamics parameters may include velocity information of the vehicle 102. In an embodiment, the vehicle dynamics parameters are collected and stored in a buffer memory associated with the vehicle 102 or the lane creation system 200.

In an embodiment, upon receiving the real-time values of the vehicle dynamics parameters and the images captured by the rear-view camera 106, the lane creation system 200 may process the received information to derive position and velocity information of the vehicle 102 and location of the other vehicles 202 in the field of view 108. In an embodiment, the location of the other vehicles 202 may be relative to the location of the vehicle 102. Subsequently, the lane creation system 200 may transform the derived vehicle dynamics parameters and the location information to a world coordinate system. The world coordinate system, also referred as the model coordinate system, may be used to indicate relative positions of the vehicle 102 and the other vehicles 202 on a two-dimensional cartesian coordinate axes ‘X’ and ‘Y’. Here, the vehicle 102 may be represented at the origin of the coordinate system and the axes ‘X’ and ‘Y’ may indicate numeric values of relative distance between the vehicle 102 and the other vehicles 202. In an embodiment, the vehicle dynamics parameters, and the detections from the rear-view camera 106 may be transformed to the world coordinate system using translation and rotation matrices.

In an embodiment, after transforming the real-time values into the world coordinate system, the lane creation system 200 may generate a bird's-eye view 204 of the vehicle 102 and a predetermined region surrounding the vehicle 102 by changing the view and/or perspective of the information on the world coordinate system, as shown in FIG. 2A. In an embodiment, the bird's-eye view 204 is an elevated view of the vehicle 102 and a region surrounding the vehicle 102 from an elevated position compared to the vehicle 102, which shows the vehicle 102 and the region surrounding the vehicle 102 as seen from above, with a perspective of the vehicle 102 and the region surrounding the vehicle 102 as though an observer is watching the vehicle 102 from some distance above the vehicle 102. After generating the bird's-eye view 204, the lane creation system 200 may draw and/or render the vehicle dynamics parameters as a virtual lane 206 of the vehicle 102 while the vehicle 102 moves forward. In other words, the virtual lane 206 may be an imaginary lane plotted on the bird's-eye view 204 of the vehicle 102 and the virtual lane 206 is indicative of a path traversed by the vehicle 102. The virtual lane 206 corresponding to the vehicle 102, which is generated form the vehicle dynamics parameters of the vehicle 102 and rendered on the bird's-eye view 204 of the vehicle 102, is shown in FIG. 2B.

In an embodiment, once the bird's-eye view 204 has been generated, any object and/or other vehicles 202 detected in the field of view 108 may be dynamically rendered on the bird's-eye view 204 of the vehicle 102. Accordingly, the bird's-eye view 204 of the vehicle 102 may be used to check if any of the detected objects or other vehicles 202 are in the virtual lane 206 of the vehicle 102. Further, when at least one of the objects or the other vehicles 202 is determined to be in the virtual lane 206 of the vehicle 102, the lane creation system 200 verifies if the detected object/vehicle is an emergency vehicle. In an embodiment, the presence of the emergency vehicle may be verified using a predetermined technique such as, based on blue-light detection technique.

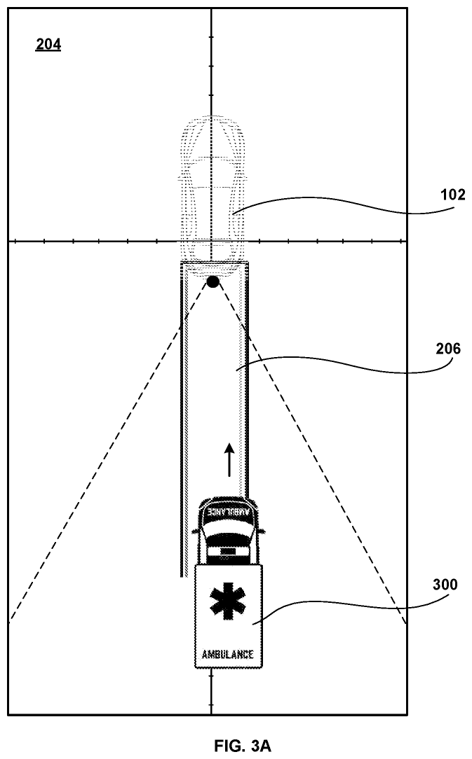

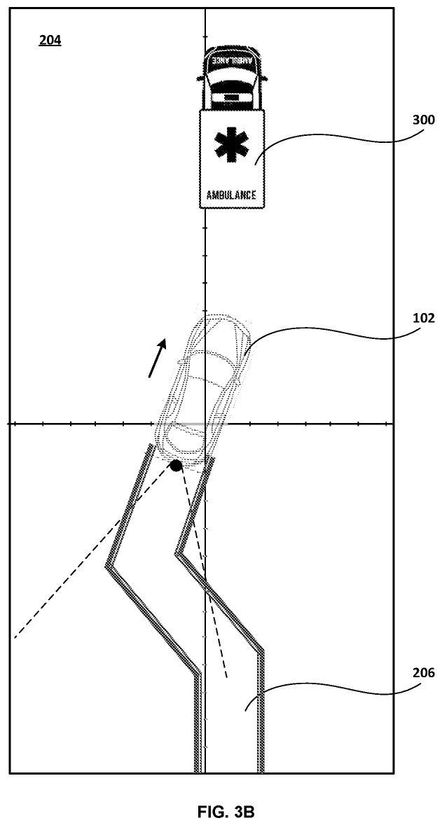

In an embodiment, after confirming that the emergency vehicle is in the virtual lane 206 of the vehicle 102, the vehicle 102 may automatically re-route and/or change the course of navigation in order to give way for the emergency vehicle which is approaching in the same lane of the vehicle 102, as illustrated in FIGS. 3A and 3B.

FIG. 3A illustrates a scenario in which an emergency vehicle 300 has been detected in the same lane of the vehicle 102, indicated by the virtual lane 206. Consequently, the vehicle 102 may move out of its current lane and give way for the emergency vehicle 300. Further, once the emergency vehicle 300 has passed by the vehicle 102, the vehicle 102 may re-adjust the path to enter the original lane, previously used by the vehicle 102, as shown in FIG. 3B.

In an embodiment, the above process may be repeated whenever an emergency vehicle 300 is detected in the field of view 108 of the rear-view camera 106 of the vehicle 102. In an embodiment, the above process may not be limited only for the case of emergency vehicle 300 and may be used for any other object or vehicle approaching the vehicle 102 from behind. Thus, the proposed method may be used for avoiding any collisions and other traffic hazards occurring from the rear side of the vehicle 102. For example, the proposed method may be used for avoiding collision with an over speeding object approaching the vehicle 102 from behind.

In an embodiment, the virtual lane 206 of the vehicle 102 may be recreated and/or reset whenever the vehicle 102 takes a curvy path. Also, the vehicle dynamics parameters stored in the buffer may be refreshed to generate a fresh virtual lane 206 for the vehicle 102.

Thus, the method and the lane creation system 200 proposed in the present disclosure, in addition to creating the virtual lane of the vehicle 102, help in accurate prediction of the lane of other objects and vehicles, for example the lane of emergency vehicle 300, without using complex, computationally heavy lane detection algorithms or the front-view cameras of the vehicle 102. The proposed disclosure may be also used in scenarios where there are no actual road lanes drawn on the roads.

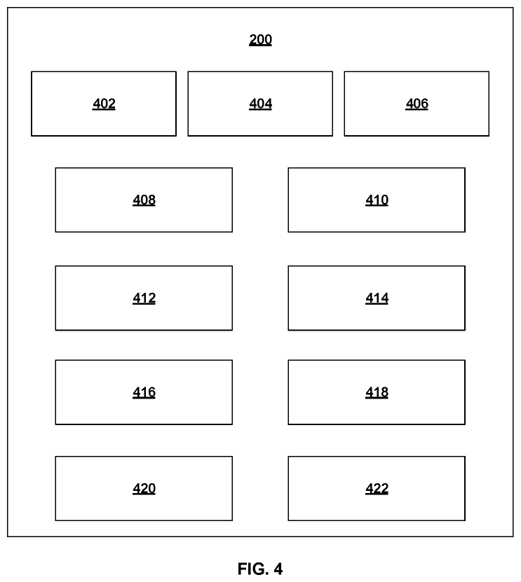

FIG. 4 shows a block diagram of a lane creation system 200 for creating a virtual lane for a vehicle 102 according to one implementation of the present disclosure.

In an implementation, the lane creation system 200 may be configured within a vehicle 102 for creating the virtual lane. Alternatively, the lane creation system 200 may be operated from a remote location and communicatively connected to the vehicle 102 over a wireless communication network. In an implementation, the lane creation system 200 may include, without limiting to, a processor 402, a memory 404 and an I/O interface 406.

In an implementation, the processor 402 may, for example, be a microcontroller or Graphics Processing Unit (GPU) capable of accessing the memory 404 to store information and execute instructions stored therein. Alternatively, the processor 402 may be a part Engine Control Unit (ECU) in the vehicle 102. In an implementation, the processor 402 and the memory 404 may be integrated on a single integrated circuit. In an implementation, the memory 404 may store information accessible by the processor 402 such as instructions executable by the processor 402 and data which may be stored, retrieved, or otherwise used by the processor 402. For example, the processor 402 may execute a method for creating the virtual lane for the vehicle 102 according to some implementations of the present disclosure based on instructions stored in the memory 404. As an example, the data stored in the memory 404 may include, without limiting to, real-time values of vehicle dynamics parameters associated with the vehicle 102, location information of the vehicle 102, one or more images captured by the rear-view camera 106 of the vehicle 102 and the like. In an implementation, the I/O interface 406 of the lane creation system 200 may be used for interfacing the lane creation system 200 with one or more other components of the vehicle 102.

In an implementation, the lane creation system 200 may include one or more functional modules including, but without limiting to, an image sensor module 408, a receiving module 410, a transforming module 412, a view generation module 414, a lane creation module 416, an objection detection module 418, an alerting module 420 and a user interface 422. In an implementation, each of the above modules may be communicatively coupled to each of the other modules via a Controller Area Network (CAN) bus in the vehicle 102. Further, each of these modules may be controlled and supervised by the processor 402 based on the instructions and data stored in the memory 404 for creating the virtual for the vehicle 102.

In an implementation, the image sensor module 408 may include at least one rear-view camera 106 along with other image sensors. In an embodiment, the rear-view camera 106 may be mounted externally on a rear side of the vehicle 102. As an example, the rear-view camera 106 may be a vision image sensor such as a mono camera or a wide-angle fisheye camera, mounted at the rear bumper of the vehicle 102. In an embodiment, the rear-view camera 106 may be configured to continuously capture one or more real-time images of a Field of View (FOV) 108 for recording one or more objects present in the rear sight of the vehicle 102, during the movement of the vehicle 102. Alternatively, the rear-view camera 106 may be configured to capture the real-time images only when an object/vehicle 202 has been detected in the FOV 108. In an implementation, the image sensor module 408 may comprise any other types and any number of cameras and image sensors, other than the ones mentioned above, according to requirement of the vehicle 102 or a manufacture of the vehicle 102.

In an embodiment, the receiving module 410 may be configured for receiving the images captured by the image sensor module 408. Additionally, the receiving module 410 may be configured for receiving real-time values of the vehicle dynamics parameters related to the vehicle 102 from one or more sensors associated with the vehicle 102.

In an embodiment, the transforming module 412 may be configured for transforming the real-time values of the vehicle dynamics parameters and the location of the one or more objects, detected from the images captured by the image sensor module 408, into a world coordinate system.

In an embodiment, view generation module 414 may be configured for generating a bird's-eye view 204 of the vehicle 102 and a predetermined region surrounding the vehicle 102 based on information from the world coordinate system. As an example, the predetermined region may be a region defined within a 10 meters radius from a current position of the vehicle 102. Thus, the predetermined region may keep changing as the vehicle 102 moves forward.

In an embodiment, the lane creation module 416 may be configured for creating a virtual lane 206 corresponding to the vehicle 102 and to render the created virtual lane 206 on the bird's-eye view 204 of the vehicle 102. In an embodiment, the lane creation module 416 may be associated with a buffer storage that stores real-time values of the vehicle dynamics parameters.

In an embodiment, the object detection module 418 may be configured for detecting one or more objects and/or other vehicles 202 in the virtual lane 206 of the vehicle 102. Additionally, the object detection module 418 may be configured for verifying if at least one of the detected objects and/or other vehicles 202 is an emergency vehicle 300.

In an embodiment, the alerting module 420 may be used for alerting the vehicle 102 or a driver and/or a passenger of the vehicle 102 when the detected objects and/or other vehicles 202 are on the virtual lane 206 of the vehicle 102. The alerts may be provided in various forms including, without limitation, an audio alert, a visual alert or by means of other physical indications like vibrations.

In an implementation, the user interface 422 may be used for displaying and/or notifying information including, without limiting to, the bird's-eye view 204 of the vehicle 102, the virtual lane 206 of the vehicle 102, indication of the emergency vehicle 300 or other objects in the virtual lane 206 of the vehicle 102 and the like, to a driver or a passenger in the vehicle 102. Further, the user interface 422 may be used for communicating audio and/or visual messages and alerts to the driver or the passenger of the vehicle 102.

In an embodiment, the user interface 422 may comprise components such as an instrument panel, an electronic display, and an audio system. The instrument panel may be a dashboard or a centre display which displays for example, a speedometer, tachometer, and warning light indicators. The user interface 422 may also comprise an electronic display such as an infotainment system or a heads-up display for communicating visual messages to the driver or the passenger and an audio system for playing audio messages, warnings, or music.

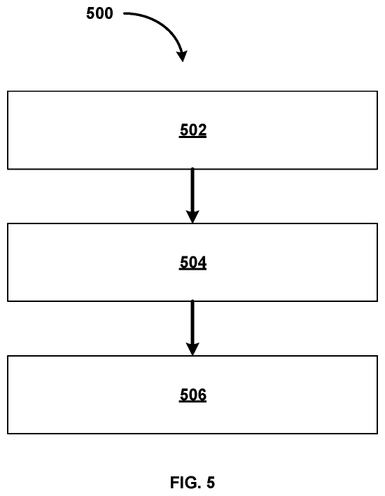

FIG. 5 is a flow diagram illustrating an exemplary method 500 for creating a virtual lane for a vehicle 300 according to an embodiment of the present disclosure.

In an implementation, the method 500 may be executed sequentially or in parallel with other implementations of this disclosure for creating the virtual lane for the vehicle 102. For instance, based on factors like number of lanes on the road 104 and intensity of traffic movement, multiple rear-view cameras, or rear-view cameras with wider field of view 108 may be used. As such, two or more processes may be executed in contemporaneously or sequentially to detect the lane of the emergency vehicle 300 using inputs from each of the rear-view cameras stated above.

The operations of the method 500 will be described with reference to the lane creation system 200 in FIG. 4. However, it will be appreciated that other similar systems may also be suitable. The method 500 starts at step 502 and may be initiated upon ignition of the vehicle 102 associated with the lane creation system 200. Other events for initiating the start of the method 500 may also be suitable and the method 500 may also be initiated on demand from a driver, passenger or even an active program running on the vehicle 102.

In step 502, the method 500 causes the processor 402 in the lane creation system 200 to transform real-time values of vehicle dynamics parameters associated with the vehicle 102 and location of one or more objects into a world coordinate system. In the world coordinate system, representative images of the vehicle 102 and the one or more objects may be indicated within a finite region in the coordinate system. In an embodiment, the vehicle dynamics parameters may be received from various gauges and sensors configured in the vehicle 102. Further, the location of the one or more objects detected by a rear-view camera 106 may be determined with the help of Global Positioning System (GPS) or navigation system associated with the vehicle 102.

In step 504, the method 500 causes the processor 402 in the lane creation system 200 to generate a bird's-eye view 204 of the vehicle 102 and a predetermined region surrounding the vehicle 102 based on the world coordinate system. As an example, the predetermined region may be a region defined within a 10 meters radius from the vehicle 102.

In step 506, the method 500 causes the processor 402 in the lane creation system 200 to create a virtual lane 206 corresponding to the vehicle 102 on the bird's-eye view 204 of the vehicle 102. In an embodiment, the virtual lane 206 may indicate the path travelled by the vehicle 102 in a predetermined time period, which may, for example, be 30 seconds. In an embodiment, the virtual lane 206 may be recreated when the direction of the virtual lane 206 changes more than a predetermined deviation angle. As an example, the predetermined deviation angle may be 60 degrees.

In an embodiment, the method 500 may comprise detecting if at least one of the one or more objects is on the virtual lane 206 of the vehicle 102. Further, the method may comprise alerting the vehicle 102 and/or a driver or a passenger of the vehicle 102, when the at least one object is detected in the virtual lane 206 of the vehicle 102. Based on the alert notification, the vehicle 102 may move to a different lane, for allowing the one or more other objects and/or vehicles (for example an emergency vehicle 300) to pass by the current lane of the vehicle 102, without obstructing the movement of the one or more other objects. Further, the vehicle 102 may revert to its original lane once the one or more other objects/vehicles pass by the vehicle 102.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for creating a virtual lane for a vehicle comprising:
transforming real-time values of vehicle dynamics parameters associated with the vehicle and location of one or more objects surrounding the vehicle into a world coordinate system with a processor;
generating with the processor a bird's-eye view of the vehicle and a predetermined region surrounding the vehicle based on the world coordinate system; and
creating with the processor a virtual lane corresponding to the vehicle on the bird's-eye view of the vehicle.

2. The method of claim 1, wherein the vehicle is at least one of an autonomous vehicle, a human-driven vehicle or an assisted driving vehicle.

3. The method of claim 1, wherein transforming the vehicle dynamics parameters comprises transforming odometry information associated with the vehicle.

4. The method of claim 1, further comprising detecting the location of the one or more objects using a rear-view camera of the vehicle during movement of the vehicle.

5. The method of claim 1 further comprising recreating the virtual lane sing the processor when direction of the virtual lane changes more than a predetermined deviation angle.

6. The method of claim 1 further comprising detecting, using the processor, when at least one of the one or more objects is in the virtual lane of the vehicle.

7. The method of claim 6 further comprising alerting the vehicle when the at least one object is detected in the virtual lane of the vehicle.

8. A lane creation system for creating a virtual lane of a vehicle comprising:
a processor; and
at least one memory coupled to the processor and storing instructions executable by the processor for:
transforming real-time values of vehicle dynamics parameters associated with the vehicle and location of one or more objects surrounding the vehicle into a world coordinate system;
generating a bird's-eye view of the vehicle and a predetermined region surrounding the vehicle based on the world coordinate system; and
creating a virtual lane corresponding to the vehicle on the bird's-eye view of the vehicle.

9. The lane creation system of claim 8, wherein the vehicle is at least one of an autonomous vehicle, a human-driven vehicle or an assisted driving vehicle.

10. The lane creation system of claim 8, wherein the vehicle dynamics parameters comprise odometry information associated with the vehicle.

11. The lane creation system of claim 8, wherein the lane creation system detects the location of the one or more objects using a rear-view camera of the vehicle, during movement of the vehicle.

12. The lane creation system of claim 8, wherein the lane creation system recreates the virtual lane when direction of the virtual lane changes more than a predetermined deviation angle.

13. The lane creation system of claim 8, wherein the lane creation system is further configured to detect if at least one of the one or more objects is in the virtual lane of the vehicle.

14. The lane creation system of claim 13, wherein the lane creation system alerts the vehicle when the at least one object is detected in the virtual lane of the vehicle.

15. A non-transitory computer-readable storage medium comprising computer-readable instructions for:
transforming real-time values of vehicle dynamics parameters associated with the vehicle and location of one or more objects surrounding the vehicle into a world coordinate system;
generating a bird's-eye view of the vehicle and a predetermined region surrounding the vehicle based on the world coordinate system; and
creating a virtual lane corresponding to the vehicle on the bird's-eye view of the vehicle.

16. The lane creation system of claim 8, wherein the lane create system is located in a vehicle.
